(19) United States
(12) Patent Application Publication
(10) Pub. No.: US 2008/0144104 A1
(43) Pub. Date: Jun. 19, 2008

(54) IMAGE FORMING DEVICE HAVING DIRECT PRINTING OPERATION AND DIRECT PRINTING METHOD THEREOF

(75) Inventor: Tae-hoi Do, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/947,995

(22) Filed: Nov. 30, 2007

(30) Foreign Application Priority Data
Dec. 14, 2006 (KR) 2006-127746

(51) Int. Cl. G06K 15/00

(52) U.S. Cl. 358/1.16

(57) ABSTRACT

An image forming device having a direct printing function and a direct printing method thereof are provided. An interface unit is connected to a movable storage medium in which a file is stored, and a user manipulation unit sets print options required to print. A control unit stores the print options set through the user manipulation unit in the movable storage medium in order to print the stored file.

### CROSS-REFERENCE TO RELATED APPLICATIONS

This application claims the benefit under 35 U.S.C. §119 from Korean Patent Application No. 2006-127746, filed on Dec. 14, 2006, in the Korean Intellectual Property Office, the entire disclosure of which is incorporated herein by reference.

### BACKGROUND OF THE INVENTION

1. Field of the Invention

The present general inventive concept relates to an image forming device having a direct printing function and a direct printing method thereof. More particularly, the present general inventive concept relates to an image forming device having a direct printing function and a direct printing method thereof, to store print options required to print in a movable storage medium and to perform a direct printing using the stored print options when a file stored in the movable storage medium is printed.

2. Description of the Related Art

An image forming device is a device having a printing function of receiving and printing data from a computer, a function of scanning or copying a file laid on a flat bed, and/or a function of transmitting scanned or copied data to an external facsimile. The image forming device may include a printer, a scanner, a copy machine, a facsimile, or a multifunctional device having two or more functions of the above described devices.

Recent image forming devices provide a direct printing function that directly loads and prints a file from a movable storage medium. If a user requests a printing of a file after selecting the file from a movable storage medium connected to an image forming device and setting diverse print options such as a number of copies, pages to be printed, and so forth, the image forming device prints the file as set in the print option.

However, if a printing work, which is in progress in the conventional image forming device, is unable to be completed due to an occurrence of an error such as a problem with the image forming device, the printing work may need to be started all over again using another image forming device, resulting in wasted time, paper and toner. In addition, since the conventional image forming device does not store the set print options in a movable storage medium, a user needs to again set the print options previously set in order to print the file through another image forming device when a print error occurs.

### SUMMARY OF THE INVENTION

The present general inventive concept provides an image forming device having a direct printing function and a direct printing method thereof, so that if an error occurs during a direct printing of a file stored in a movable storage medium, it is not required for a user to re-set print options to print and to re-print the file from a beginning.

Additional aspects and utilities of the present general inventive concept will be set forth in part in the description which follows and, in part, will be obvious from the description, or may be learned by practice of the general inventive concept.

The foregoing and other aspects and utilities of the present general concept may be achieved by providing an image forming device having a direct printing function which includes an interface unit connected to a movable storage medium in which a file is stored, a user manipulation unit to set print options required to print the file, and a control unit to store the print options set through the user manipulation unit in the movable storage medium to print the stored file.

The image forming device may further include a print engine unit to print the file on a basis of the stored print options, wherein the control unit updates print progress information, which is changed as the print engine unit proceeds with the printing of the file, in the movable storage medium.

The print progress information being updated may include at least one of a number of copies, of which the printing has been completed, among a total number of copies set for the file, and a number of pages, of which the printing has been completed, among a total number of pages that constitute the file.

The control unit may operate to delete the stored print options from the movable storage medium when the printing of the file is completed on a basis of the set print options.

The control unit may operate to store the print options that include the print progress information finally updated in the movable storage medium if an error occurs during the printing of the file on the basis of the stored print options.

The control unit may generate and output a message to confirm whether the printing of the file is in progress if it is determined that the print options are pre-stored in the movable storage medium connected thereto, and may operate to print the file on a basis of the pre-stored print options if the printing of the file is selected through the user manipulation unit.

The control unit may perform a continued printing of the file, starting after a page of which the printing has been completed, as many as a number of copies of which the printing has not yet been completed, if the pre-stored print options include information on a number of copies of which the printing has been completed among a total number of copies set for the file and the pages of which the printing has been completed.

The image forming device may further include a display unit to display the message to select whether to proceed with the continued printing through the user manipulation unit, wherein if the print options are pre-stored, the control unit generates the message to ask whether to proceed with the continued printing, and to control the display unit to display the message.

The foregoing and/or other aspects and utilities of the general inventive concept may also be achieved by providing a direct printing method for an image forming device, the method including an image forming device connecting to a movable storage medium in which a file is stored, setting print options required to print the file and to store the set print options in the movable storage medium.

The direct printing method may further include if the printing of the file is requested, printing the file on a basis of the stored print options and updating print progress information, which is changed as the printing of the file progresses, in the movable storage medium.

The direct printing method may further include deleting the print options stored in the movable storage medium when the printing of the file is completed.

The direct printing method may further include storing the print options that include the print progress information finally updated in the movable storage medium if an error occurs during the printing of the file on the basis of the stored print options.

The direct printing method according to embodiments of the present invention may further include confirming whether the print options are pre-stored in the movable storage medium if the movable storage medium is connected before the setting the print options, generating and displaying a message to confirm whether the printing of the file is in progress if the print options are pre-stored and printing the file on a basis of the print options pre-stored in the movable storage medium if the printing of the file is selected.

The printing the file may perform a continued printing of the file, starting after a page of which the printing has been completed, as many as a number of copies of which the printing has not yet been completed, if the pre-stored print options include information on as number of copies of which the printing has been completed among a total number of copies set for the file and the page of which the printing has been completed.

The direct printing method may further include generating and displaying the message to confirm whether to proceed with the continued printing if the printing of the file is selected, wherein the printing the file may include performing the continued printing if the proceeding of the continued printing is selected, and printing the file from its first page if the proceeding of the continued printing is not selected.

The foregoing and/or other aspects and utilities of the general inventive concept may also be achieved by providing a computer-readable medium containing computer readable codes as a program to execute a method, the method including receiving a file and one or more print options corresponding to the file from a movable storage medium, and performing a printing operation of printing the file according to the one or more print options.

### BRIEF DESCRIPTION OF THE DRAWINGS

These and/or other aspects and utilities of the present general inventive concept will become apparent and more readily appreciated from the following description of the embodiments taken in conjunction with reference to the accompanying drawings, in which:

FIG. 1 is a block diagram illustrating an image forming device having a direct printing function according to an embodiment of the present general inventive concept;

FIG. 2 is a view illustrating print options stored in a movable storage medium connected to an interface unit illustrated in FIG. 1;

FIGS. 3 and 4 are views illustrating examples of messages being displayed on a display unit illustrated in FIG. 1;

FIG. 5 is a flowchart illustrating a direct printing method for an image forming device illustrated in FIG. 1;

FIG. 6 is a flowchart illustrating a direct printing method for an image forming device when a movable storage medium in which print options are pre-stored is connected to an interface unit illustrated in FIG. 1; and

FIG. 7 is a flowchart schematically illustrating a direct printing method for an image forming device according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

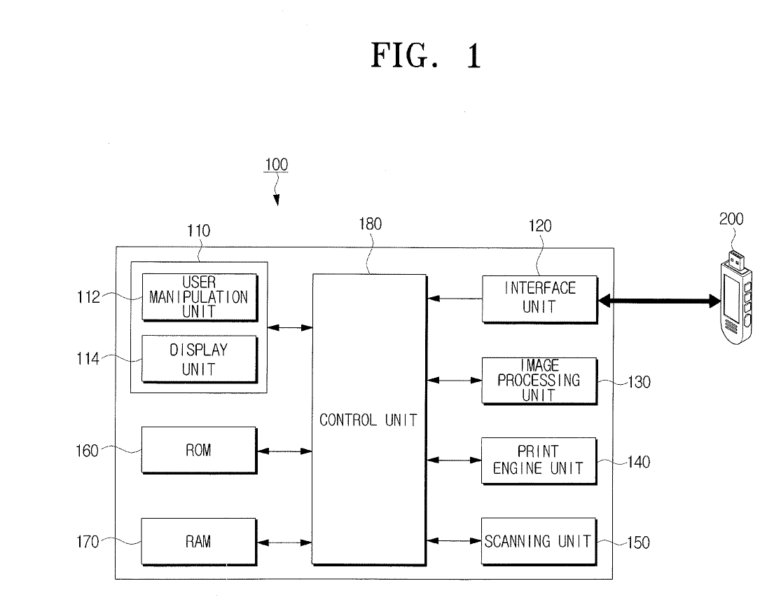

FIG. 1 is a block diagram illustrating an image forming device having a direct printing function according to an embodiment of the present general inventive concept.

Referring to FIG. 1, the image forming device 100 having a direct printing function according to an embodiment of the present general inventive concept includes an operation panel unit 110, an interface unit 120, an image processing unit 130, a print engine unit 140, a scanning unit 150, a ROM 160, a RAM 170, and a control unit 180.

The operation panel unit 110 has a user manipulation unit 112 and a display unit 114 in order to support an interface between a user and the image forming device 100. The user manipulation unit 112 outputs signals to select, manipulate and request respective functions supported by the image forming device 100 to the control unit 180, and is provided with various types of function keys and a touch screen.

In particular, the user selects a file to be printed from a file list stored in a movable storage medium 200 and sets print options of the selected file by manipulating the user manipulation unit 112. The print options refer to conditions required to print the file, and have diverse items such as the number of copies, resolution, mono print or color print, reduction rate of printing, and so forth. The set print options are stored in the RAM 170 or the movable storage medium 200.

The display unit 114, under the control of the control unit 180, displays a current state of the image forming device 100, attribute information of a file being currently printed, a file list stored in the movable storage medium 200, a guide message generated by the control unit 180, and so forth. The display unit 114 can be implemented by an LCD (Liquid Crystal Display), a CRT (Cathode Ray Tube), a PDP (Plasma Display Panel), and so forth.

The interface unit 120 supports communication paths between a plurality of external devices and the image forming device 100, and has a port connected to a digital image capturing device such as a digital camera and a personal computer via a USB (Universal Serial Bus) cable and so on, and a port directly connected to the movable storage medium 200 such as an HDD (Hard Disk Drive).

In particular, if the interface unit 120 is connected to the movable storage medium 200, the interface unit 120 outputs the file list stored in the movable storage medium 200 to the control unit 180, and transmits the print options set using the user manipulation unit 112 and print progress information that is changed during the printing of the file to the movable storage medium 200. If a file to be printed among files stored in the movable storage medium 200 is selected and the print options of the selected file are set, the set print options are stored in the movable storage medium 200. If the printing of the file starts, the print progress information being changed is updated in the file that indicates the print options of the movable storage medium 200.

The image processing unit 130 reads an image of the file from the movable storage medium 200 mounted on the interface unit 120, and converts the resolution, a file format, and so forth, of the image to suit the image forming device 100. The converted image is stored in a nonvolatile memory such as the ROM 160, is transmitted to the personal computer (not illustrated) through the interface unit 120, or is printed by the print engine unit 140, in accordance with a user's request.

The print engine unit 140 prints an image scanned by the scanning unit 150 or an image of the file transmitted from the movable storage medium 200 through the interface unit 120 in accordance with the set print options. In this case, the print engine unit 140 fuses the image on the printing paper by heating at a proper temperature and pressing the printing paper.

The scanning unit 150 scans a document laid on a flat bed (not illustrated) and generates a scanned image. The scanned image is input to the image processing unit 130 that adjusts the resolution of the image as needed, and then is stored in the ROM 160 or is printed by the print engine unit 140.

The ROM 160 stores therein various types of control programs and drive programs required to implement the function/operation of the image forming device 100, and particularly firmware required to store the print options set by the user manipulation unit 112 in the movable storage medium 200 and firmware capable of recognizing and decoding the print options stored in the movable storage medium 200. In addition, the ROM 160 selectively stores the scanned image generated by the scanning unit 150, the printed image, and so forth.

The RAM 170 temporarily stores various types of data generated during the operation of the image forming device 100. For example, the RAM 170 temporarily stores the print options required when the file stored in the movable storage medium 200 is printed and the print progress information that is changed during the printing of the file.

The control unit 180 controls the operation of the image forming device 100 using a pre-stored control program, and controls signal input/output of the above-described blocks.

In particular, if the movable storage medium 200 is connected to the interface unit 120, the control unit 180 operates to read the file list stored in the movable storage medium 200 and to display the read file list on the display unit 114. If the file to be printed in the file list and the print options of the file are selected through the user manipulation unit 112, the control unit 180 operates to map the set print options onto the selected file and to store the set print options in the movable storage medium 200.

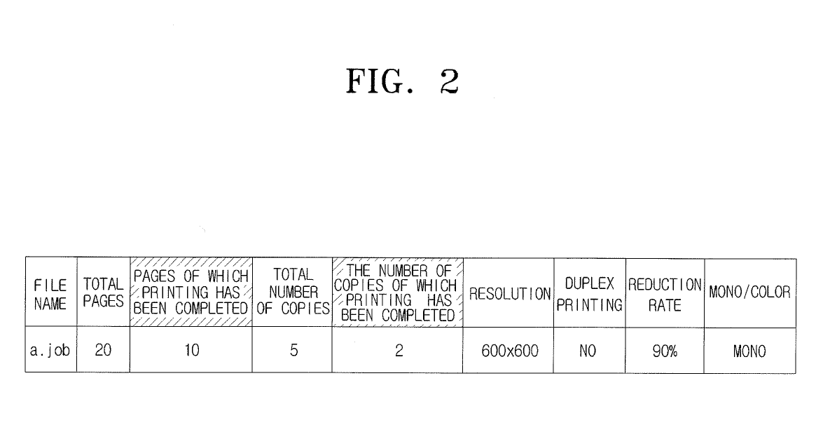

The set print options have diverse items such as the number of copies, resolution, mono print or color print, reduction rate of printing, and so forth, and values set for the respective items. The print progress items, such as the number of copies of the printing that has been completed and a number of pages of the printing that has been completed, are added to the print options under the control of the control unit 180. That is, the print options stored in the movable storage medium 200 have items as illustrated in FIG. 2. The values of the print progress items such as the number of copies of the printing that has been completed and the number of pages of the printing that has been completed, i.e., the print progress information, are updated whenever the printing of the file is performed, but other values are not updated to the values set by the user manipulation unit 112.

If the printing of the selected file starts, the control unit 180 updates the number of pages, of which the printing has been completed among the print options stored in the movable storage medium 200, whenever the printing of each page is completed. That is, if the printing of the first page is completed, “1” is written in the item of the number of pages of which the printing has been completed, and then if the printing of the second page is completed, “2” is written in the item of the number of pages of which the printing has been completed. Also, where the number of copies is set to “5”, the control unit 180 controls the movable storage medium 200 to write “1” in the item of the number of copies of which the printing has been completed if the printing of the first sheet is completed, and then to write “2” in the items of the number of copies if the printing of the second sheet is completed.

In addition, if the printing of the selected file is completed based on the set print options, the control unit 180 deletes the print options stored in the movable storage medium 200. If the control unit 180 cannot proceed with the printing due to an error occurring in the image forming device 100 before the completion of the printing of the selected file, however, it does not delete the print options stored in the movable storage medium 200.

Accordingly, the print options including the print progress information finally updated are still stored in the movable storage medium 200 even if the printing is stopped due to the error, and thus if the movable storage medium 200 is connected to another device that can interpret the stored print options, the device can print the corresponding file using the stored print options. Thus, the printing of the file can be completed without user's re-setting of the print options.

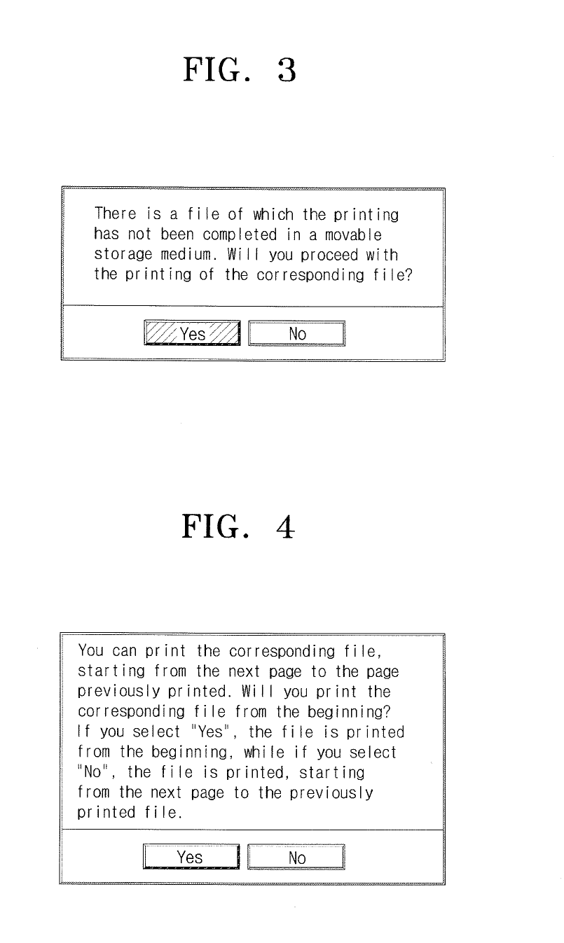

Alternatively, if it is detected that the movable storage medium 200 is connected to the interface unit 120, the control unit 180 confirms whether the print options of the file have been stored in the movable storage medium 200. If the print options of the file have already been stored as a result of confirming, the control unit 180 determines that there is a file of which the print job has not been completed due to an error occurring during the print operation of another image forming device (not illustrated). Then, the control unit 180 generates a guide message as illustrated in FIG. 3, and controls the display unit 114 to display the guide message.

Referring to FIG. 3, the control unit 180 may control the image processing unit 130 to generate a guide message such as “There is a file of which the printing has not been completed in the movable storage medium. Will you proceed with the printing of the corresponding file?”. If “Yes” is selected, the control unit 180 controls the interface unit 120, the image processing unit 130 and the print engine unit 140 to read the corresponding file from the movable storage medium 200 and to print the read file.

By contrast, if “No” is selected, the control unit 180 reads and processes the file list stored in the movable storage medium 200, and then controls the image processing unit 130 and the display unit 114 to display the file list. That is, in the case of printing the corresponding file with other print options, the user may select “No” in the displayed message as illustrated in FIG. 3, select the corresponding file in the displayed file list, and then set desired print options.

If “Yes” is selected in the guide message as illustrated in FIG. 3, the control unit 180 may operate to display a message as illustrated in FIG. 4. Referring to FIG. 4, the control unit 180 may operate to display a message such as “The corresponding file can be printed from the next page to the page previously printed. Will you print the corresponding file from the beginning?” If “Yes” is selected, the control unit 180 controls the print engine unit 140 to print the file, starting from the first page of the file, while if “No” is selected, the control unit controls the print engine unit 140 to print the file, starting from the next page to the previously printed page.

For example, if “No” is selected as illustrated in FIG. 4 in a state that the print options of the corresponding file are as illustrated in FIG. 2, the control unit 180 determines that the five copies of 20 pages have previously been printed and the previous printing stopped after printing on the 10^{th} page of the sixth copy. Accordingly, the control unit 180 controls the print engine unit 140 to start the printing from the 11^{th} page of the sixth copy and to print 11^{th} to 20^{th} pages of the sixth copy and four more copies of 20 pages. Further, the control unit 180 controls the movable storage medium 200 to update the number of pages of which the printing has been completed whenever the printing is performed in the unit of a page and to update the number of copies of which the printing has been completed whenever the printing is performed in the unit of a sheet.

In FIG. 4, where “Yes” is selected can be usefully used in a situation where the user does not have the previously printed sheets.

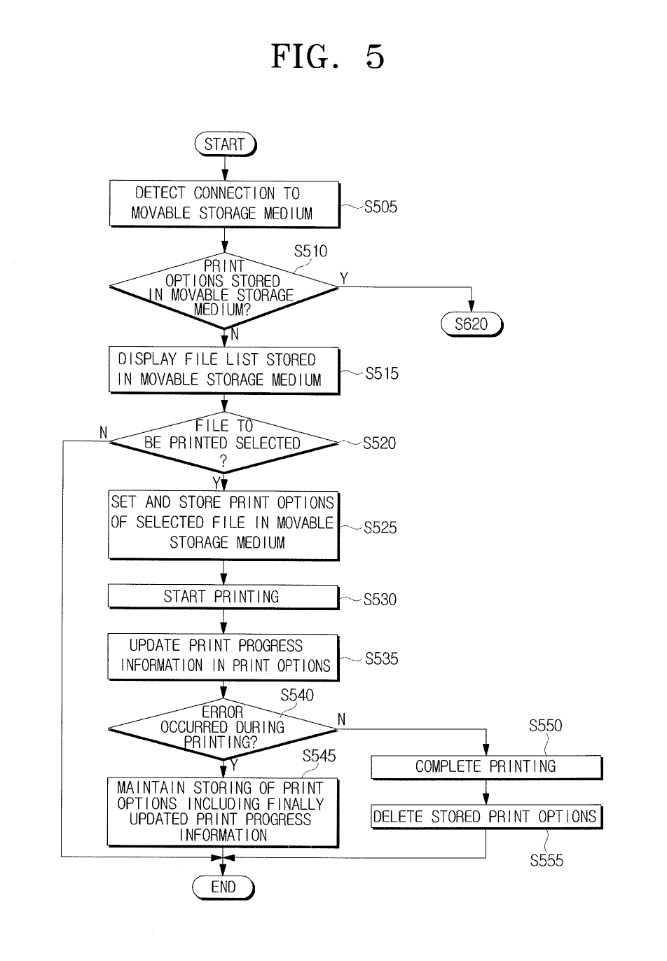

FIG. 5 is a flowchart illustrating a direct printing method for an image forming device illustrated in FIG. 1.

Referring to FIGS. 1 to 5, if it is detected that the movable storage medium 200 is connected to the interface unit 120 at operation (S505), the control unit 180 confirms whether the print options are stored in the movable storage medium 200 at operation S510.

If it is confirmed at operation (S510) that the print options are not stored in the movable storage medium 200, the control unit 180 operates to read the file list stored in the movable storage medium 200, and controls the display unit 114 to display the read file list at operation (S515).

If the print options of the selected file is set through the user manipulation unit 112 after the file to be printed is selected from the file list displayed on the display unit 114 through the user manipulation unit 112 at operation (S520), the control unit 180 maps the set print options onto the selected file and stores the mapped print options in the movable storage medium 200 at operation (S525).

If the operation (S525) proceeds, the control unit 180 controls the image processing unit 130 and the print engine unit 140 to process and print the selected file based on the set print options at operation (S530).

The control unit 180 updates the print progress information, which is changed whenever the printing of the file is performed by the print engine unit 140, in the print options of the movable storage medium 200 at operation (S535). The updated print progress information includes the number of copies, of the printing that has been completed, among the total number of copies set for the file, and the number of pages, of which the printing has been completed, among the total number of pages constituting the file.

If an error occurs in the image forming device 100 during the printing of the file at operation (S540), the control unit 180 operates to store the print options that include the print progress information finally updated at operation (S535) in the movable storage medium 200 at operation (S545).

By contrast, if the printing is completed without an error occurrence at operation (S550), the control unit 180 deletes the print options stored in the movable storage medium 200 at operation (S555). This is to prevent in advance the control unit 180 from misjudging that there is a file of which the printing has not been completed in the movable storage medium 200 when the same movable storage medium 200 is re-connected to the image forming device 100. The deletion of the print options is performed in the same manner even when the movable storage medium 200 is connected to another image forming device (not illustrated). At operation (S555), whether to delete the print options can be selectively determined.

If it is determined at operation (S510) that the print options are pre-stored in the movable storage medium 200, the control unit 180 proceeds to operation (S620).

Referring to FIG. 5, in the case of printing a file stored in the movable storage medium 200, the print options required to print the file are stored in the movable storage medium 200, and then are deleted when the printing is completed. If an error occurs during the printing, the stored print options are maintained. Accordingly, when the movable storage medium 200 is connected to another image forming device (not illustrated) or re-connected to the image forming device 100 after removing the error, the printing of the file of which the printing has not been completed can be performed without the necessity of re-setting the print options.

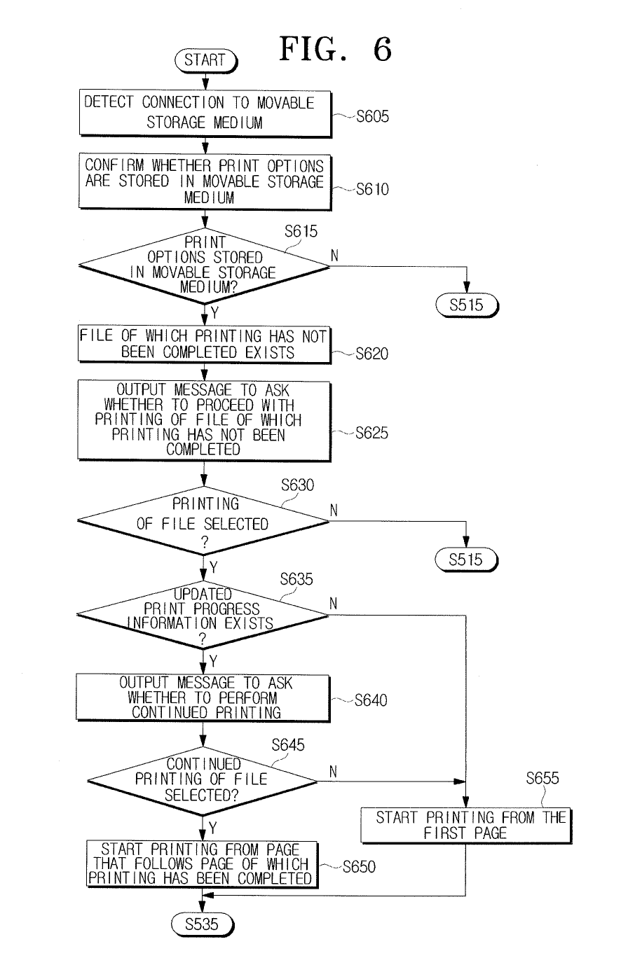

FIG. 6 is a flowchart illustrating a direct printing method for an image forming device when a movable storage medium in which print options are pre-stored is connected to an interface unit illustrated in FIG. 1.

Referring to FIGS. 1 to 6, if it is detected that the movable storage medium 200 is connected to the interface unit 120 at operation (S605), the control unit 180 confirms whether the print options are pre-stored in the movable storage medium 200 at operation (S610).

If it is confirmed at operation (S610) that the print options are pre-stored in the movable storage medium 200, the control unit 180 determines that the file of which the printing has not been completed exists in the movable storage medium 200 at operation (S620).

Then, the control unit 180 controls the image processing unit 130 and the display unit 114 to generate and display a message to select whether to proceed with the printing of the file of which the printing has not been completed at operation (S625). The message displayed at operation (S625) is a message to inform a user that there is a file of which the printing has not been completed due to an error occurring in the image forming device during the printing of the file or according to a user's intention, and asking whether to proceed with the printing of the corresponding file. Although not illustrated in FIG. 3, it is apparent that the control unit 180 can also display the name of the file of which the printing has not been completed.

If “Yes” is selected in the displayed message through the user manipulation unit 112 at operation (S630), the control unit 180 confirms whether the confirmed print options include the updated print progress information at operation (S635).

If it is confirmed that the print options include the print progress information as illustrated in FIG. 2 at operation (S635), the control unit 180 generates and displays on the display device 114 the message to select whether to print the corresponding file from the beginning or to perform a continued printing of the file as illustrated in FIG. 4 at operation (S640).

If the continued printing is selected, i.e., if “No” is selected, at operation (S645) in the message displayed at operation (S640), the control unit 180, according to the printing process information, controls the print engine unit 140 to resume printing from the page following the last printed page. That is, the control unit 180 controls the print engine unit 140 to start the printing of the selected file from the 11^{th} page. Accordingly, the control unit 180 controls the print engine unit 140 to print 1^{st} to 20^{th} pages four times after once printing 11^{th} to 20^{th} pages of the selected file. Then, the control unit 180 proceeds to operation (S535).

For example, at operation (S535), the control unit 180 updates the number of pages of which the printing has been completed whenever a page is printed. If 11^{th} to 20^{th} pages are printed, the control unit 180 updates the number of copies of which the printing has been completed to “6”, and if the four times printing of the 1^{st} to 20^{th} pages is completed, the control unit 180 finally updates the number of copies of which the printing has been completed to “10”.

By contrast, if it is determined that the print options are not stored in the movable storage medium 200 at operation (S615), the control unit 180 proceeds to operation S515 as illustrated in FIG. 5.

Also, if the printing of the corresponding file is not selected at operation S630, the control unit 180 proceeds to operation S515 as illustrated in FIG. 5.

In addition, if it is confirmed that the updated print progress information does not exist in the print options at operation (S635) or the continued printing is not selected at operation (S645), the control unit 180 controls the print engine unit 140 to print the corresponding file from the first page at operation (S655).

In the present embodiment of the present general inventive concept as described above, the print options of the selected file can be deleted by a user's selection after the printing of the file is completed. Although the control unit 180 automatically deletes the print options in the embodiment of the present general inventive concept, it is also possible to design the device to delete the print options only when the user requests such deletion of the print options. Accordingly, if it is intended to re-print the file with the same print options after the printing of the corresponding file is successfully performed, it is not required for the user to re-set the print options.

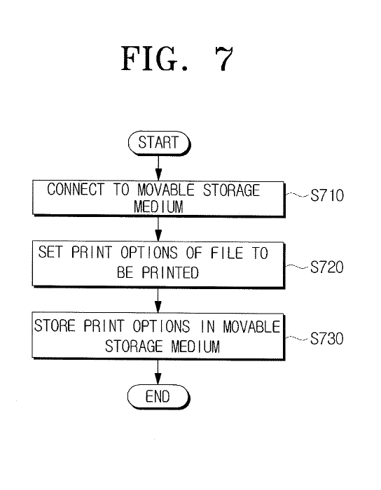

FIG. 7 is a flowchart schematically illustrating a direct printing method for an image forming device according to an embodiment of the present general inventive concept.

Referring to FIGS. 1 and 7, if the movable storage medium 200 is connected to the image forming device 100 at operation S710, the user sets the print options required to print by manipulating the user manipulation unit 112 at operation (S720). If operation S720 is completed, the control unit 180 operates to store the set print options in the movable storage medium 200 at operation (S730).

If another image forming device (not illustrated) intends to print the file stored in the movable storage medium 200 with the same print options, it can print the corresponding file using the previously stored print options, and thus it is not required for the user to re-set the print options.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to various embodiments of the image forming device having a direct printing function and the direct printing method according the present general inventive concept, in the case of directly printing data stored in a movable storage medium, print options required to print are stored in the movable storage medium, and if the printing is not completed due to an error occurrence during the printing, the print options required to print are not deleted, so that a corresponding file can be printed with the same print options without re-setting the print options.

In particular, where printing a file using pre-stored print options, a user can select either a continued printing to start the printing of the file from the next page to the previously printed page or a re-printing of the file from the beginning.

In addition, if a user intends to print a file stored in a movable storage medium through an other image forming device, the other image forming device performs the printing of the file using the previously stored print options, and thus it is not required for the user to re-set the print options to improve the user's convenience.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming device having a direct printing function, the image forming device comprising:
an interface unit connected to a movable storage medium in which a file is stored;
a user manipulation unit to set print options required to print the file; and
a control unit to store the print options set through the user manipulation unit in the movable storage medium to print the stored file.

2. The image forming device of claim 1, further comprising:
a print engine unit to print the file on a basis of the stored print options;
wherein the control unit updates print progress information, which is changed as the print engine unit proceeds with the printing of the file, in the movable storage medium.

3. The image forming device of claim 2, wherein the print progress information being updated includes at least one of a number of copies, of which the printing has been completed, among a total number of copies set for the file, and a number of pages, of which the printing has been completed, among a total number of pages that constitute the file.

4. The image forming device of claim 1, wherein the control unit operates to delete the stored print options from the movable storage medium when the printing of the file is completed on a basis of the set print options.

5. The image forming device of claim 2, wherein the control unit operates to store the print options that include the print progress information finally updated in the movable storage medium if an error occurs during the printing of the file on the basis of the stored print options.

6. The image forming device of claim 1, wherein the control unit:
generates and outputs a message to confirm whether the printing of the file is in progress if it is determined that the print options are pre-stored in the movable storage medium connected thereto; and
operates to print the file on a basis of the pre-stored print options if the printing of the file is selected through the user manipulation unit.

7. The image forming device of claim 6, wherein the control unit performs a continued printing of the file, starting after a page of which the printing has been completed, as many as a number of copies of which the printing has not yet been completed, if the pre-stored print options include information on a number of copies of which the printing has been completed among a total number of copies set for the file and the pages of which the printing has been completed.

8. The image forming device of claim 7, further comprising:
a display unit to display the message to select whether to proceed with the continued printing through the user manipulation unit;
wherein if the print options are pre-stored, the control unit generates the message to ask whether to proceed with the continued printing, and controls the display unit to display the message.

9. A direct printing method for an image forming device, the method comprising:
connecting an image forming device to a movable storage medium in which a file is stored;
setting print options required to print the file; and
storing the set print options in the movable storage medium.

10. The direct printing method of claim 9, further comprising:
if the printing of the file is requested, printing the file on a basis of the stored print options; and
updating print progress information, which is changed as the printing of the file is in progresses, in the movable storage medium.

11. The direct printing method of claim 10, wherein the print progress information being updated includes at least one of a number of copies, of which the printing has been completed, among a total number of copies set for the file, and a number of pages, of which the printing has been completed, among a total number of pages that constitute the file.

12. The direct printing method of claim 9, further comprising:
deleting the print options stored in the movable storage medium when the printing of the file is completed.

13. The direct printing method of claim 10, further comprising:
storing the print options that include the print progress information finally updated in the movable storage medium if an error occurs during the printing of the file on the basis of the stored print options.

14. The direct printing method of claim 9, further comprising:
confirming whether the print options are pre-stored in the movable storage medium if the movable storage medium is connected before the setting the print options;
generating and displaying a message to confirm whether the printing of the file is in progress if the print options are pre-stored; and
printing the file on a basis of the print options pre-stored in the movable storage medium if the printing of the file is selected.

15. The direct printing method of claim 14, wherein the printing the file performs a continued printing of the file, starting after a page of which the printing has been completed, as many as a number of copies of which the printing has not yet been completed, if the pre-stored print options include information on a number of copies of which the printing has been completed among a total number of copies set for the file and the page of which the printing has been completed.

16. The direct printing method of claim 15, further comprising:
generating and displaying the message to confirm whether to proceed with the continued printing if the printing of the file is selected;
wherein the operation of printing the file includes performing the continued printing if the proceeding of the continued printing is selected, and printing the file from its first page if the proceeding of the continued printing is not selected.

17. A computer-readable medium containing computer readable codes as a program to execute a method, the method comprising
receiving a file and one or more print options corresponding to the file from a movable storage medium; and
performing a printing operation of printing the file according to the one or more print options.
